(19) United States
(12) Patent Application Publication
(10) Pub. No.: US 2018/0371231 A1
(43) Pub. Date: Dec. 27, 2018

(54) PROCESS FOR MANUFACTURING SOLUTIONS OF ALKYLATED AMINO FORMALDEHYDE RESINS HAVING A LOW FREE FORMALDEHYDE CONTENT

(71) Applicant: INEOS MELAMINES GMBH, Frankfurt am Main (DE)

(72) Inventors: Gunther SEIFERT, Krefeld (DE); Achim VOELKER, OFFENBACH (DE); Johann WONNER, Abtweiler (DE)

(21) Appl. No.: 16/063,596

(22) PCT Filed: Dec. 13, 2016
(86) PCT No.: PCT/EP2016/002099

§ 371 Date: Jun. 18, 2018

(30) Foreign Application Priority Data
Dec. 16, 2015 (EP) EP15003582.2

(51) Int. Cl. C08L 61/28; C08K 5/05

(52) U.S. Cl. CPC C08L 61/28; C08G 12/422; C08K 5/05

(57) ABSTRACT

Process for manufacturing solutions of alkylated amino formaldehyde resins having a free formaldehyde content of <0.5% by weight, based on the complete weight of the solution, wherein (a) an amino compound selected from the group consisting of melamine, guanamine, urea, toluenesulphoneamide and glycoluril is methylolated, (b) the methylolated amino compound is alkylated with at least one monoalcohol, (c) the surplus monoalcohol is removed quantitatively, and (d) the remaining residue consisting of or consisting essentially of the alkylated amino formaldehyde resin is dissolved in at least one aprotic solvent.

### FIELD OF THE INVENTION

The present invention relates to alkylated amino formaldehyde resins.

In particular, the present invention relates to a process for manufacturing solutions of alkylated amino formaldehyde resins having a low free formaldehyde content.

Moreover, the present invention relates to the solutions of alkylated amino formaldehyde resins manufactured in accordance with the process of the invention.

### BACKGROUND OF THE INVENTION

Due to the reclassification of formaldehyde as being carcinogenic, it has become necessary to look for new ways to manufacture solutions of alkylated amino formaldehyde resins having a particularly low free formaldehyde content.

Processes for manufacturing solutions of alkylated amino formaldehyde resins are well-known in the art.

Thus, the American patent U.S. application Ser. No. 552,997 discloses a method for the preparation of solutions of butylated aminotriazine formaldehyde resins in xylene or butanol-xylene mixtures.

The British patent GB 724,972 also discloses a method for the preparation of solutions of butylated aminotriazine formaldehyde resins and their miscibility with mineral spirits, xylene and butanol.

The American U.S. Pat. No. 2,918,452 discloses a method for the preparation of solutions of methylated and butylated aminotriazine formaldehyde resins in xylene.

The German published examined application 15 19 327 discloses the preparation of solutions of isobutylated aminotriazine formaldehyde resins in xylene-isobutanol mixtures.

Additionally, the American U.S. Pat. No. 4,039,493 discloses the preparation of various mixed alkylated aminotriazine formaldehyde resins and their miscibility with xylene.

Moreover, the German patent application DE 10 2005 036 584 A1 discloses the preparation of various mixed alkylated aminotriazine formaldehyde resins, i.e. mixed ethers. According to page 7, paragraph [0089] of the application, the mixed ethers can be dissolved in any customary and known solvents. In the pages 7 to 8, paragraphs [0090] to [0105] various protic and aprotic solvents are listed. No mention is made as to whether the nature of the solvent has any influence on the formaldehyde content of the solutions. DE 10 2005 036 584 A1 recites free formaldehyde contents, however, these are the formaldehyde contents of the solid reaction products.

All the references cited above remain silent about the influence of solvents of different nature on the formaldehyde content of solutions of alkylated aminotriazine formaldehyde resins.

Therefore, it has been the object of the present invention to develop a simple but highly effective process for manufacturing solutions of alkylated amino formaldehyde resins.

The object is solved by the process claimed in the independent claim 1. The various advantages embodiments can be taken from the dependent claims.

The process of the invention is directed to the manufacturing of solutions of alkylated amino formaldehyde resins having a free formaldehyde content of <0.5% by weight, preferably <0.4% by weight and most preferably <0.3% by weight, the weight percentages being based on the complete weight of the solutions.

The alkyl groups of the alkylated amino formaldehyde resins are preferably selected from alkyl groups having 1 to 12 carbon atoms. More preferably, the alkyl groups are selected from the group consisting of methyl, ethyl, propyl, isopropyl, n-butyl, isobutyl, secondary butyl, tertiary butyl, amyl, hexyl, heptyl, octyl, nonyl, decyl, cyclopentyl, cyclohexyl, methyl cyclohexyl, trimethyl cyclohexyl, furfuryl, benzyl, methyl benzyl and diacetone-1-yl groups. Most preferably, the alkyl groups are selected from methyl, n-butyl, and isobutyl groups.

The amino compound is selected from the group consisting of melamine, guanamine, preferably benzoguanamine, urea, toluenesulphoneamide and glycoluril. Most preferably, the amino compound is selected from melamine, benzoguanamine, toluenesulphoneamide and urea.

In the first step of the process of the invention, at least one amino compound is methylolated either partially or completely meaning that only some or all of the amino groups present are reacted with formaldehyde to yield N-methylol groups (hydroxymethyl groups).

The conditions for the methylolation reactions have been described in detail in the prior art and need not be discussed here.

In the second step of the process of the invention, the methylolated amino compound is alkylated (etherified) with at least one monoalcohol.

Preferably, the monoalcohol is selected from the group consisting of methanol, ethanol, propanol, isopropanol, n-butanol, isobutanol, secondary butanol tertiary butanol, amyl alcohols, hexanols, heptanols, octanols, nonanols, decanols, cyclopentanol, cyclohexanol, methylcyclohexanols, trimethylcyclohexanols, furfurylalcohol, benzyl alcohol, methylbenzyl alcohol and diacetone alcohol. Most preferably the monoalcohol is selected from methanol, n-butanol and isobutanol.

The monoalcohol employed for the alkylation (etherification) can also serve as the solvent for the reactants

Also the conditions for the alkylation reactions have been described in detail in the prior art and need not to be discussed here.

In the third process step, the surplus monoalcohol and/or solvent is or are removed quantitatively, preferably by distillation, most preferably by vacuum distillation.

In the fourth step of the process of the invention, the remaining residue consisting of or consisting essentially of the alkylated amino formaldehyde resin is dissolved in a least one aprotic solvent.

Preferably, the aprotic solvent selected from the group consisting of alkanes, cycloaliphatic hydrocarbons, terpene hydrocarbons and terpenoids, aromatic hydrocarbons, chlorinated hydrocarbons, ketones, esters, ethers, glycol ethers N,N-dimethylformamide, N,N-dimethylacetamide, N-methylpyrrolidone, hexamethyl phosphoric triamide, dimethyl sulfoxide, tetramethylene sulfone and 1,3-dimethyl-2-imidazolidinone.

Preferably, the alkanes are selected from the isomeric pentanes, isomeric hexanes, isomeric heptanes, isomeric octanes, isomeric nonanes and isomeric decanes; the cycloaliphatic hydrocarbons are selected from the group consisting of cyclohexane, methyl cyclohexane, tetralin and decalin; the terpene hydrocarbons and terpenoids are selected from the group consisting of turpentine oil, root turpentine oil, wood oil, pine oil and terpineol; the aromatic hydrocarbons are selected from the group consisting of toluene, xylene, ethylbenzene and cumene; the chlorinated hydrocarbons are selected from the group consisting of dichloromethane, trichloromethane, tetrachloromethane, 1,2-dichloroethane, 1,1,2,2-tetrachloroethane, 1,1,1-trichloroethane, 1,2-dichloroethylene, trichloroethylene, perchloroethylene, 1,2-dichloropropane and chlorobenzene; the ketones are selected from the group consisting of acetone, methyl ethyl ketone, methyl propyl ketone, methyl isopropyl ketone, methyl butyl ketone, methyl isobutyl ketone, methyl amyl ketone, ethyl amyl ketone, diisopropyl ketone, dipropyl ketone, diisobutyl ketone, mesityl oxide, cyclohexanone, methyl cyclohexanone, dimethyl cyclohexanone, trimethyl cyclohexanone and isophorone; the esters are selected from the group consisting of methyl formate, ethyl formate, butyl formate, isobutyl formate, methyl acetate, ethyl acetate, propyl acetate, butyl acetate, isobutyl acetate, secondary butyl acetate, amyl acetate, 2-ethylhexyl acetate, octyl acetate, nonyl acetate, hexyl acetate, cyclohexyl acetate, benzyl acetate, methyl glycol acetate, ethyl glycol acetate, butyl glycol acetate, ethyl diglycol acetate, butyl diglycol acetate, 1-methoxy propyl acetate, 2-methoxy propyl acetate, ethoxypropyl acetate, 3-methoxy butyl acetate, ethyl 3-ethoxy propionate, butyl butyrate, butyl isobutyrate, ethyl lactate, butyl lactate, butyl glycolate, dimethyl adipate, dimethyl glutarate, dimethyl succinate, ethylene carbonate, propene carbonates and butyrolactone; the ethers are selected from the group consisting of diethyl ether, diisopropyl ether, dibutyl ether, methyl tertiary butyl ether, tetrahydrofurane, 1,4-dioxane and metadioxane; the glycol ethers are selected from the group consisting of diethylene glycol dimethyl ether, diethylene glycol diethyl ether and diethylene glycol dipropyl ether.

Most preferably, the aprotic solvent is xylene.

Without wishing to be bound by any theory it is believed that protic solvents like n-butanol or isobutanol can form semi-acetals with formaldehyde and, therefore, compete for the formaldehyde bound to the amino compound. When an aprotic solvent is used instead of an alcohol, no semi-acetals can be formed. The chemical equilibrium lies therefore primarily on the side of the formaldehyde bound to the amino compounds as methylol groups as intended.

The non-volatile content of the solutions prepared in accordance with the process of the invention can be from 60 to 95% by weight, based on the complete weight of the solution. However, higher or lower non-volatile contents are also possible, when they are particularly required for special purposes.

The solutions prepared in accordance with the process of the invention are excellently suited as crosslinkers for nucleophilic groups, as for example, hydroxyl, amino or sulfhydryl (—SH) groups containing binder resins for coatings.

The following examples are set forth as representative of the present invention. These examples are not to be construed as limiting the scope of the invention as these and other equivalent embodiments will be apparent in view of the present disclosure and the appended claims.

### Examples 1 to 3 and Comparative Experiments A to C

### Preparation Example

### General Procedure for Preparing Alkylated Benzoguanamine Formaldehyde Resins

Benzoguanamine, paraformaldehyde, n-butanol and formic acid (85%) were charged into a 2 L three necked flask with a stirrer, the reflux condenser, a thermometer and a heating bath. The mixture was heated up to the reaction temperature and held at this temperature for a defined period of time. Thereafter, the mixture was heated to reflux and the separation of water was started until a defined temperature was reached. The reaction mixture was neutralized and the pH value was adjusted with caustic soda. Thereafter, the solvent (n-butanol) was completely removed by vacuum distillation. The residue present was then diluted with xylene and adjusted to the desired non-volatile content.

### Example 1 and Comparative Experiment A

### The Preparation of Solutions of Butylated Benzoguanamine Formaldehyde Resins

### Example 1

In a three neck round bottom flask, 748 g of an alkylated benzoguanamine formaldehyde resin having a dynamic viscosity DIN EN ISO 3251 (cone & plate, 23° C.) of 450 to 650 mPa.s, a density at 23° C. of approximately 1.04 g/mL, a formaldehyde content DIN EN ISO 11402 4.3 of <1% by weight based on the complete weight of the resin, and a molecular weight distribution of 1.38 was diluted with 110 g xylene and filtered. The non-volatile content of the product was now about 80% by weight, based on the complete weight of the solution. After the addition of the final amount of xylene the non-volatile contents was reduced to 70% by weight, based on the complete weight of the solution. The free formaldehyde content was measured to be only 0.06% by weight, based on the complete weight of the solution.

### Comparative Experiment A

Example 1 was repeated with the difference that n-butanol was used as the solvent. The free formaldehyde content of the solution was measured to be 0.63% by weight, based on the complete weight of the solution.

### Example 2

1,250 g of an alkylated benzoguanamine formaldehyde resin having a dynamic viscosity DIN EN ISO (cone & plate, 23° C.) of 1000-2000, a formaldehyde content DIN EN ISO 11402 4.3 of <1%, based on the complete weight of the resin, at a molecular weight distribution of 1.2 were distilled under a vacuum of 150 mbar until a temperature of 110° C. was reached. After cooling down, 176 g of o-xylene were added resulting in a non-volatile content of the resulting solution of 80% by weight, based on the complete weight of the solution. The free formaldehyde content was measured to be 0.05% by weight, based on the complete weight of the solution.

### Comparative Experiment B

Example 2 was repeated with the difference that n-butanol was used as the solvent. The free formaldehyde content of the solution was measured to be 0.74% by weight, based on the complete weight of the solution.

### Example 3

1050 g of the mixture of an alkylated melamine formaldehyde resins and an alkylated benzoguanamine formaldehyde resin having a dynamic viscosity EN ISO 3219-B (cone & plate, 23° C.) of 1000-3000 mPa.s, a free formaldehyde content DIN EN ISO 11402 4.3 of <1.3 and a molecular weight distribution of 1.3 were distilled in a vacuum of 150 mbar until a temperature of 110° C. was reached. After cooling down, 176 g of o-xylene were added resulting in non-volatile content of the resulting solution of 80% by weight, based on the complete weight of the solution. The free formaldehyde content was measured to be 0.21% by weight, based on the complete weight of the solution.

### Comparative Experiment C

Example 3 was repeated with the difference that n-butanol was used as the solvent. The free formaldehyde content of the solution was measured to be 0.74% by weight, based on the complete weight of the solution.

### Example 4 and Comparative Example D

Melamine, paraformaldehyde, n-butanol and formic acid (85%) were charged into a 2 L three necked flask equipped with a stirrer, a reflux condenser, a thermometer and a heating bath. The mixture was heated up to a certain temperature and the separation of the water was started until a defined temperature was reached. The reaction mixture was neutralized and the pH value was adjusted with caustic soda. Then, the solvent n-butanol was removed quantitatively in vacuum. The residue were then diluted with xylene and adjusted to the desired non-volatile content.

2093 g of the residue having a non-volatile content of 98.6% by weight, based on the complete weight of the residue, was diluted with 882 g of xylene so that the non-volatile content of 65% by weight was achieved. The free formaldehyde of the solution was measured to be 0.28%, based on the complete weight of the solution.

### Comparative Experiment D

Example 4 was repeated with the difference that n-butanol was used as the solvent. The free formaldehyde content of the solution was measured to be 1.04% by weight, based on the complete weight of the solution.

1. A process for manufacturing a solution of an alkylated amino formaldehyde resin having a free formaldehyde content of <0.5% by weight based on the complete weight of the solution, the process comprising:
methylolating an amino compound selected from the group consisting of melamine, guanamine, urea, toluenesulphone amide and glycoluril to provide a methylolated amino compound,
alkylating the methylolated amino compound with at least one monoalcohol,
removing a surplus monoalcohol to obtain a remaining residue consisting essentially of the alkylated amino formaldehyde resin, and
dissolving the remaining residue in at least one aprotic solvent.

2. The process of claim 1, wherein the guanamine is benzoguanamin.

3. The process of claim 1, wherein the monoalcohol is selected from the group consisting of methanol, ethanol, propanol, isopropanol, n-butanol, isobutanol, secondary butanol tertiary butanol, amyl alcohols, hexanols, heptanols, octanols, nonanols, decanols, cyclopentanol, cyclohexanol, methylcyclohexanols, trimethylcyclohexanols, furfurylalcohol, benzyl alcohol, methylbenzyl alcohol and diacetone alcohol.

4. The process of claim 1, wherein the monoalcohol is n-butanol, isobutanol or methanol.

5. The process of claim 1, wherein the remaining residue is a methylated, n-butylated and/or isobutylated amino formaldehyde resin.

6. The process of claim 1, wherein the aprotic solvent selected from the group consisting of alkanes, cycloaliphatic hydrocarbons, terpene hydrocarbons and terpenoids, aromatic hydrocarbons, chlorinated hydrocarbons, ketones, esters, ethers, glycol ethers N,N-dimethylformamide, N,N-dimethylacetamide, N-methylpyrrolidone, hexamethyl phosphoric triamide, dimethyl sulfoxide, tetramethylene sulfone and 1,3-dimethyl-2-imidazolidinone.

7. The process of claim 6 wherein the alkanes are selected from the isomeric pentanes, isomeric hexanes, isomeric heptanes, isomeric octanes, isomeric nonanes and isomeric decanes; the cycloaliphatic hydrocarbons are selected from the group consisting of cyclohexane, methyl cyclohexane, tetralin and decalin; the terpene hydrocarbons and terpenoids are selected from the group consisting of turpentine oil, root turpentine oil, wood oil, pine oil and terpineol; the aromatic hydrocarbons are selected from the group consisting of toluene, xylene, ethylbenzene and cumene; the chlorinated hydrocarbons are selected from the group consisting of dichloromethane, trichloromethane, tetrachloromethane, 1,2-dichloroethane, 1,1,2,2-tetrachloroethane, 1,1,1-trichloroethane, 1,2-dichloroethylene, trichloroethylene, perchloroethylene, 1,2-dichloropropane and chlorobenzene; the ketones are selected from the group consisting of acetone, methyl ethyl ketone, methyl propyl ketone, methyl isopropyl ketone, methyl butyl ketone, methyl isobutyl ketone, methyl amyl ketone, ethyl amyl ketone, diisopropyl ketone, dipropyl ketone, diisobutyl ketone, mesityl oxide, cyclohexanone, methyl cyclohexanone, dimethyl cyclohexanone, trimethyl cyclohexanone and isophorone; the esters are selected from the group consisting of methyl formate, ethyl formate, butyl formate, isobutyl formate, methyl acetate, ethyl acetate, propyl acetate, butyl acetate, isobutyl acetate, secondary butyl acetate, amyl acetate, 2-ethylhexyl acetate, octyl acetate, nonyl acetate, hexyl acetate, cyclohexyl acetate, benzyl acetate, methyl glycol acetate, ethyl glycol acetate, butyl glycol acetate, ethyl diglycol acetate, butyl diglycol acetate, 1-methoxy propyl acetate, 2-methoxy propyl acetate, ethoxypropyl acetate, 3-methoxy butyl acetate, ethyl 3-ethoxy propionate, butyl butyrate, butyl isobutyrate, ethyl lactate, butyl lactate, butyl glycolate, dimethyl adipate, dimethyl glutarate, dimethyl succinate, ethylene carbonate, propene carbonates and butyrolactone; the ethers are selected from the group consisting of diethyl ether, diisopropyl ether, dibutyl ether, methyl tertiary butyl ether, tetrahydrofurane, 1,4-dioxane and metadioxane; the glycol ethers are selected from the group consisting of diethylene glycol dimethyl ether, diethylene glycol diethyl ether and diethylene glycol dipropyl ether.

8. The process of claim 1, wherein the aprotic solvent is xylene.

9. The process of claim 1, wherein the solution has a non-volatile content of from 60 to 95% by weight, based on the complete weight of the solution.

10. The process of claim 1, wherein the solution has a free formaldehyde content <0.3% by weight, based on the complete weight of the solution.

11. A method to cross-link nucleophilic groups of a binder resin, the method comprising:
mixing the binder resin with an effective amount of a solution manufactured in accordance with claim 1.

12. The process of claim 6, wherein the aprotic solvent selected from the group consisting of alkanes, and cycloaliphatic hydrocarbons.

13. The process of claim 12, wherein the alkanes, and cycloaliphatic hydrocarbons each have 7-9 carbon atoms.
